(19) United States
(12) Patent Application Publication
(10) Pub. No.: US 2008/0005988 A1
(43) Pub. Date: Jan. 10, 2008

(54) Floor or wall covering

(76) Inventor: Michael Dombowsky, Saskatchewan (CA)

Correspondence Address: ADE & COMPANY INC., 2157 Henderson Highway, WINNIPEG, MB, R2G1P9, US

(21) Appl. No.: 11/481,397

(22) Filed: Jul. 6, 2006

(51) Int. Cl. B44F 7/00

(52) U.S. Cl. 52/314

(57) ABSTRACT

A metal-stone floor or wall covering, more particularly a “hard surface” floor covering is created in plant by stamping large panels from sheet metal with an interlocking reversing notched edge. This allows each large panel to lock into additional panel sufficient to cover a floor area, whereupon the sheet metal in plant is covered with cross linking polymer cement mixed with crushed powdered stone and the resulting slurry is applied over the surface of the sheet metal in a thin layer and allowed to harden. Grout line grooves are carved into the mixed overlay and filled with a latex grout which is then allowed to harden after which, the tile is colorized, and then sealed with a clear coat, dried and shipped to site for bonding in place by beads of a foamed adhesive which allow some flexing of the floor as an integral structure.

This invention relates to a floor or wall covering material and particularly a floor and wall covering material arranged to simulate ceramic, porcelain or stone tile.

### BACKGROUND OF THE INVENTION

In recent years, laminate floors have simplified and have improved the efficiency of the installation of real and simulated hardwood floors. However, ceramic and porcelain and stone tile flooring has changed very little and while the marketplace desires hard surface floor coverings that are attractive and durable, ceramic and porcelain are by nature heavy, hard and brittle, time consuming to install and require extensive surface preparation for installation. In addition when it comes to changing the floor covering the process of removing ceramic and porcelain and stone is messy and time consuming.

### SUMMARY OF THE INVENTION

It is one object of the invention to provide an improved floor or wall covering material which simulates tile.

According to one aspect of the invention there is provided a floor or wall covering comprising:

a plurality of flooring panels;

each panel including a flat sheet formed from sheet metal;

the sheet being shaped in plan such that the panels can be arranged in an array to cover a floor;

each sheet being covered by a set layer of a covering material arranged to simulate tile;

the layer of each panel having grooves formed therein to simulate grout lines;

the grooves being filled by a grout material;

the layer being colored by a coloring material;

the layer being covered by a clear coat.

In a flooring arrangement to form a continuous floor covering for a substrate, each panel has along the side edges thereof recesses and projections thereon for connecting to corresponding projections and recesses on the side edge of a next adjacent panel allowing the panels to interconnect to cover a floor area and wherein the panels are formed into an interconnected array by each panel being laid next to and interlocked with the adjacent panel to form one entire connected surface which essentially floats over the existing floor to form a resilient floor that will flex.

Preferably the panels are applied onto an existing flooring by a layer of a urethane foam or similar flexible material.

Preferably the polyurethane foam is dispensed from a gun applicator in spaced rows so that the flooring is resilient.

Preferably the sheets are stamped from sheet metal.

Preferably the panels are rectangular and more preferably square.

Preferably the projections and recesses form a castellated shape along the edge.

Preferably the projections have side edges which are inclined outwardly to now all the same size increase in width away from the side edge and the recesses are shaped to match to form an interlocking reversing notched edge.

The covering material is preferably polymer concrete. However there are numerous coatings available like epoxies and powder coats and other new coatings that will arise, all of which create the wear and aesthetic surface, most of which will be considered contemporary, however, most often, initially the product will use the polymer/cement coatings containing an aggregate to simulate sandstone, and limestone.

Preferably the aggregate is a crushed powdered stone.

Preferably layer is applied at a manufacturing plant as a slurry which is applied over the surface of the sheet metal in a thin layer and allowed to harden.

Preferably the grout lines on the interior of the sheet are grouted with a latex grout.

Preferably the sheet is a flexible 14 to 16 gauge sheet.

Preferably each panel is locked into the next tile by tapping the projections and recesses forming opposing angled mortise shapes together.

Preferably the panels form an entirely joined floor in all directions which allows the floor covering to float over any stable substrate.

Preferably the locked joints between panels are sealed with a liquid sealer which prevents water penetration.

The locked joints between panels may be connected together with liquid glue. There is enough friction in most cases to connect the panels so the liquid sealer is mostly for prevention of water penetration, minor on the gluing of panels together.

In an arrangement designed for use with the above flooring system to form an under-floor radiant heating system, there is provided a sheet of a high density foam underneath the panel and on top of a sub floor. This application for Radiant floor is a significant development as compared to the alternatives available today.

Preferably the sheet of foam provides a support for heating coils.

In another aspect, each panel can be shaped to fit on a single stair tread.

In this arrangement, each stair panel may include a front nose portion bent at right angles to extend downwardly and bent back to extend rearwardly to cover a tread nose of the stair tread.

In this arrangement, there is provided a second tread portion to form a kick plate for the stair tread.

According to a further aspect, there is provided a method for creating and installing a metal-stone floor covering, more particularly a “hard surface” floor covering that is created in plant by stamping large panels from sheet metal with an interlocking reversing notched edge. This allows each large panel to lock into additional panel sufficient to cover a floor area, whereupon the sheet metal in plant is covered with cross linking polymer cement mixed with crushed powdered stone and the resulting slurry is applied over the surface of the sheet metal in a thin layer and allowed to harden. Other appropriate coatings may be used. Grout lines are carved into the mixed overlay and then allowed to harden after which, the tile is colorized, and then sealed with a clear coat, dried and shipped to site.

The panels can be installed over existing flooring including cracked concrete, old ceramic or vinyl tile or new wood or concrete substrates by applying urethane foam from a gun dispenser into which the panel is laid and additional panels are laid next to and interlocked with the adjacent panel to form one entire connected surface which essentially floats over the existing floor providing a resilient floor that will flex but not crack, thereby greatly extending the life and performance of the floor covering.

Thus another features is to provide a method for creating a resilient and durable panel flooring that can be created in a plant in a more completed form and in larger sheets thereby allowing several tiles to be arrayed on the panel, which may include accent tile or mosaics, all applied to the surface of the sheet metal. After the polymer cementitious coating or other cures, color and clear coat is added and again cured. Next, all grout lines on the interior of the larger sheet are grouted with a latex grout. All of these processes are done on a tabletop for easy access instead of on the knees for traditional tile setting.

A second object of the present invention is to provide a method for installing the tile over a variety of substrates without the need of traditional tile setters. This is accomplished by laying the flexible 14 to 16 gauge sheet metal tiles onto the floor, which is glued to the floor with polyurethane foam, dispensed from a gun applicator in rows 6 inches on center. This allows the new metal-stone to be resilient. Each tile is locked into the next tile by tapping the opposing angled mortise shapes together, which is stamped out of the perimeter of the tile in the plant. This connecting of each tile creates an entirely joined floor in all directions and in turn, allows the metal-stone floor tile to float over any stable substrate. After all tile are laid over the existing floor, the locked joints of the tile are sealed with a liquid sealer which prevents water penetration and welds each metal sheet together with liquid glue. Next, the joints are grouted to match the tile in the center of each larger tile that was grouted in the plant.

### BRIEF DESCRIPTION OF THE DRAWINGS

One embodiment of the invention will now be described in conjunction with the accompanying drawings in which:

FIG. 1 illustrates two sheet metal tiles 44″×44″ each with the opposing serrated edge.

FIG. 2 illustrates 4 tile locked together.

FIG. 3 illustrates a close up of the 4 tile locked together at the junction point.

FIG. 4 illustrates two separate large tile with smaller tile applied to the surface.

FIG. 5 illustrates the profile of the tile with the joint grouted on the interior of the larger tile.

FIG. 6 illustrates the profile of the tile with the joint between two joined tiles grouted.

FIG. 7 is a plan view of a foam panel for use under the panels of FIGS. 1 through 6 as a base on a sub-floor.

FIG. 8 is a side elevational view of the panel of FIG. 7.

FIG. 9 is a cross sectional view through the panel with the flooring applied thereon.

FIG. 10 is a top plan view of a number of the panels of FIG. 7.

FIG. 11 is a top plan view of a number of the panels including a flooring panel.

FIG. 12 is a cross sectional view through a stair showing a series of threads on which is applied the flooring system of the present invention.

FIG. 13 is an exploded view of the flooring system only of FIG. 12.

In the drawings like characters of reference indicate corresponding parts in the different figures.

### DETAILED DESCRIPTION

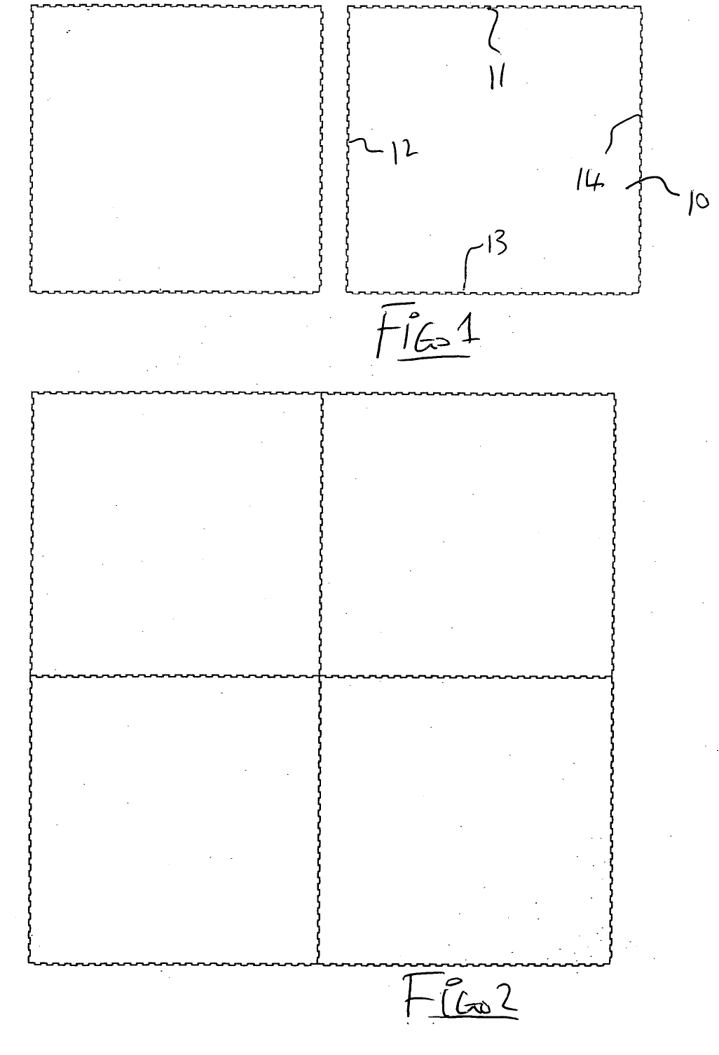

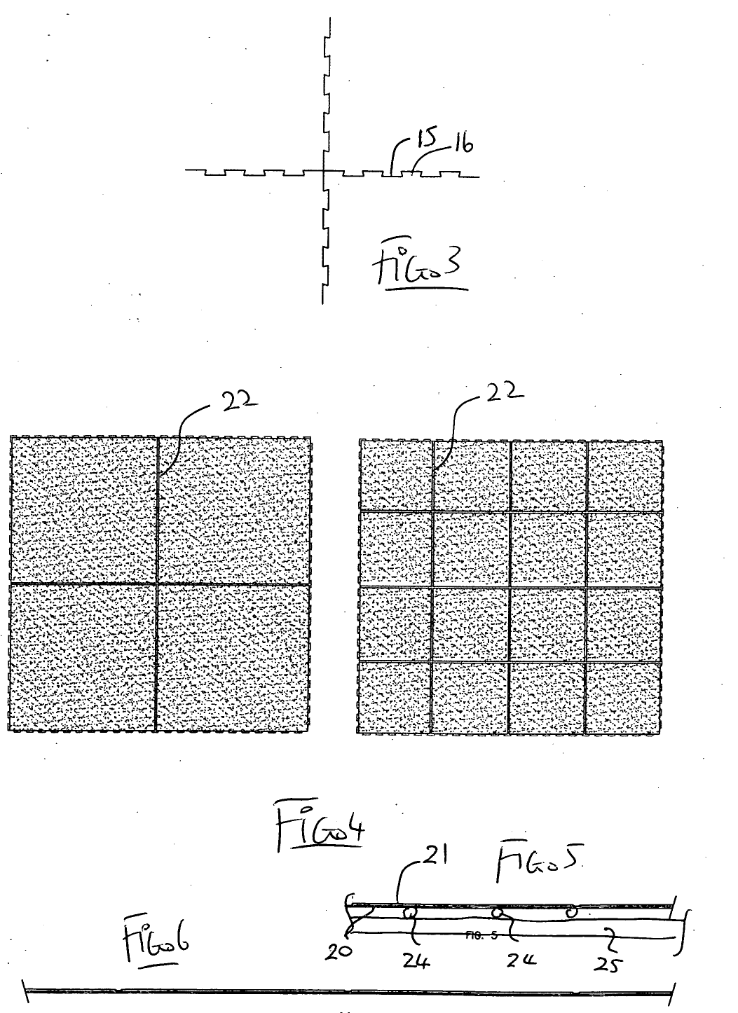

In FIGS. 1 and 2 is shown a series of the panels of the present invention each of which is rectangular, preferably square, in plan to form four side edges. Thus the panel is indicated at 10 and includes side edges 11, 12, 13 and 14. In FIG. 1 the panels are arranged side by side ready to be connected edge to edge. In FIG. 2 the panels are shown in plan view with four of the panels connected edge to edge to form an array of the panels which defines a part of a floor covering to cover an existing substrate.

FIG. 3 shows an enlarged view of the edges of the panels at a junction between four of the panels so that the projections and recesses can be seen in more detail. Thus at the side edges of the panels there are provided recesses 15 and projections 16 arranged side by side in a castellated manner along the side edge. The projections are relatively small having a distance from the side edge only of the order of ⅛ to ¼ inch. The tiles are symmetrical at the corners which allows any given tile to be laid in any of 4 directions increase in width in a direction away from the side edge whereas the recesses are opposed to this so as to form an interlocking structure which requires to be locked by vertical movement of one sheet onto the next sheet in a mortis-type shape.

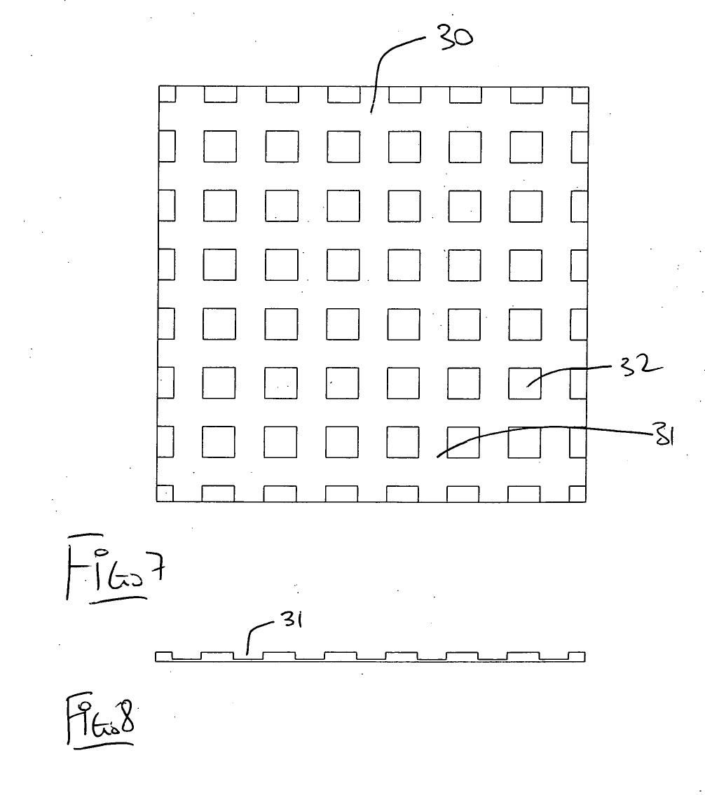

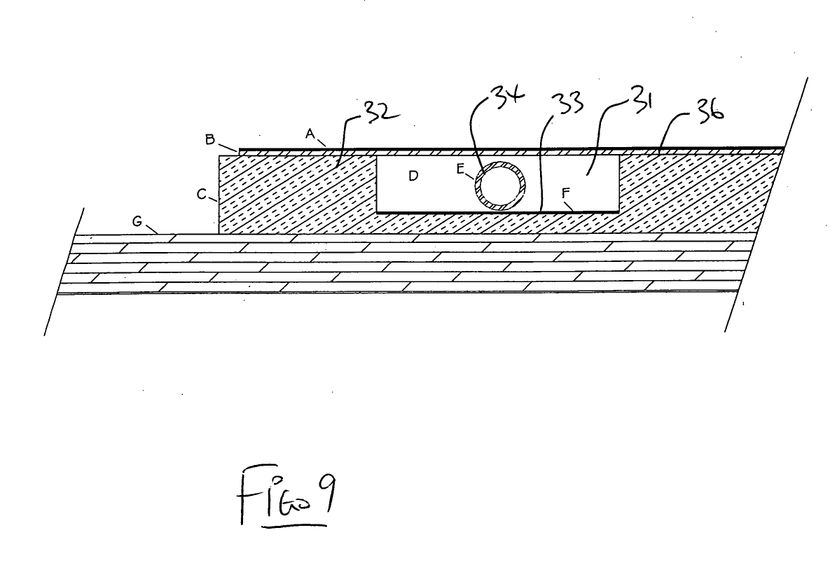

In FIGS. 4, 5 and 6 are shown two of the panels. In each panel there is an underlying sheet 20 formed from a sheet metal on top of which is applied a layer 21 formed from the polymer concrete containing an aggregate in the form of crushed and powered stone.

The thickness of the sheet metal lies in the range 14 to 16 gauge. The thickness of the polymer concrete lies in the range 0.050 to 0.075 inch.

Polymer concrete of a suitable type is available from Perma-Crete and arrangements of this type are well known. In the thickness defined above, the metal sheet covered by the polymer concrete layer is sufficient flexible to accommodate slight movements in the sub-floor and slight inaccuracies in the sub-floor.

The coating layer is applied containing the aggregate and is allowed to set. When set grout lines 22 are formed in the layer in the form of machined grooves which reduce the thickness of the layer and may reach to the underlying sheet material thus removing the layer in the groove concerned.

Preferably after colouring of the layer with a suitable colouring agent and coating of the layer by a clear coat, the grout lines 22 are filled with a conventional latex grout so as to simulate the appearance of tile.

Suitable colouring agents are well known allowing many different colours to be provided.

A clear coat is preferably of the type manufactured by Perma-Crete.

The layer is formed so that it does not extend into the projections on the side edges leaving these projections bare or free from the layer. When the panels are therefore laid edge to edge and interconnected by the intermeshing projections and recesses, this leaves a strip along the side edges which is arranged to match the width of the grout grooves 22. Thus the projections are relatively small and will have a width of the order of ⅛ to ¼ inch which matches the conventional width of a grout line.

Thus when the panels are laid edge to edge and connected, the panels provide the appearance simulating tile. The panels are laid on a series of beads or strips 24 of a foamed adhesive material such as a polyurethane foam which is dispensed from a gun or similar device which provides the bead 24. The beads are spaced sufficiently to allow the panel to be slightly spaced from the sub-floor 25 giving some flexibility. The beads will of course be compressed when pressure is applied onto the panel pressing it against the sub-floor but there will remain some spaces between the beads or strips of the foam material.

After connection of the panels and the laying of the panels on the sub-floor, the panels are connected edge to edge by a liquid glue primarily for sealing from water which attaches the projections and recesses together in a fixed meshing arrangement without the possibility of these elements separating and a panel loosing contact with the sub-floor. The locked joints can then be sealed with a liquid sealer.

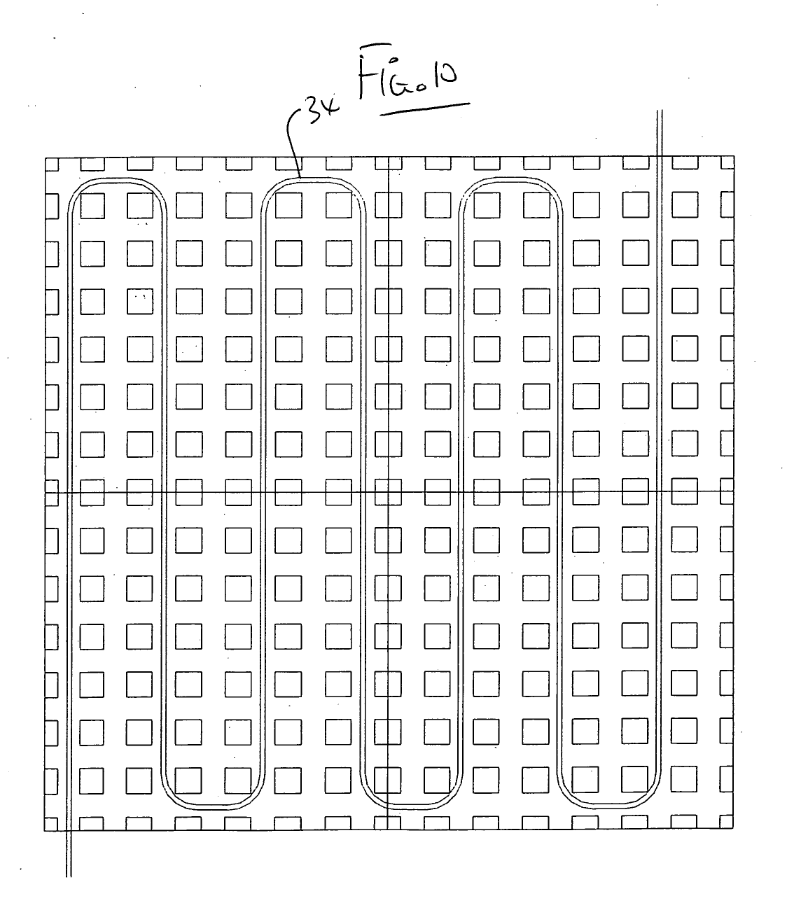

Turning now to FIGS. 7 and 8 there is shown an arrangement for an in-floor heating system in which panels previously described are laid onto a panel or sheet 30 of a substantially rigid foam material such as high density EPS foam. The foam is formed with a series of recesses 31 in its upper surface. The foam may be cut into shape or may be moulded in shape as required. The recesses or voids 31 are arranged in an array of channels at right angles on the surface of the panel with the channels being separated by raised protuberances 32.

As shown in the cross section of FIG. 9, the base of each channel 31 has a layer 33 of a reflective tape which radiates heat from a heat source 34 inserted in the recess 31. The heat source 34 may be an electric source or may be a hot water source as is well known. Preferably the heat source 34 is a radiant heat pipe which sits within the channel. The floor panels previously described as indicated at 36 are applied on top of the raised projecting portions 32 using a adhesive in the form of the polyurethane foam previously described. Again therefore the panels are arranged edge to edge an interconnected by the projecting portions along the side edges in the manner described above. The use of the steel sheet as the substrate for the panel ensures an effective communication or transfer of heat from the heat source 34 across the entire surface of the panel.

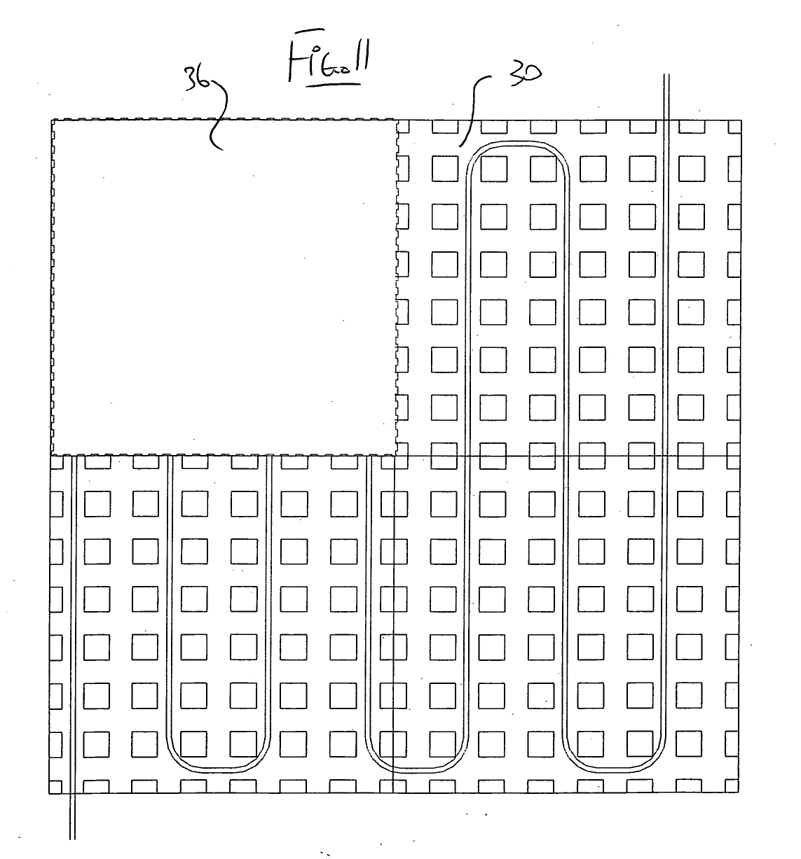

In FIG. 10 is shown a series of such panels on which the heat source 34 is applied in a convoluted path in conventional manner.

In FIG. 11 a single one of the panels 36 is applied over the foam substrate panels 30.

Thus the flooring system including the foamed panels 30 and the flooring panels 36 provides a simple effective system simulating the appearance of tile and yet cheaply and efficiently forming a hard wearing surface covering the heat source. The system can be applied quickly and efficiently over an existing sub-floor while accommodating some flexing of that sub-floor and some inaccuracies in the surface structure. Presently, in existing buildings, the structure would not have been engineered to accept the additional weight that 1½″ of gyp-crete or 2″ of fibermesh concrete would add to a structure and therefore retrofitting existing buildings for radiant heat is generally not feasible. Conversely, this invention provides a solution for a radiant heat retrofit that add no more weight than most traditional floor coverings. (I am not sure if this fits here of better, earlier in the descriptions?)

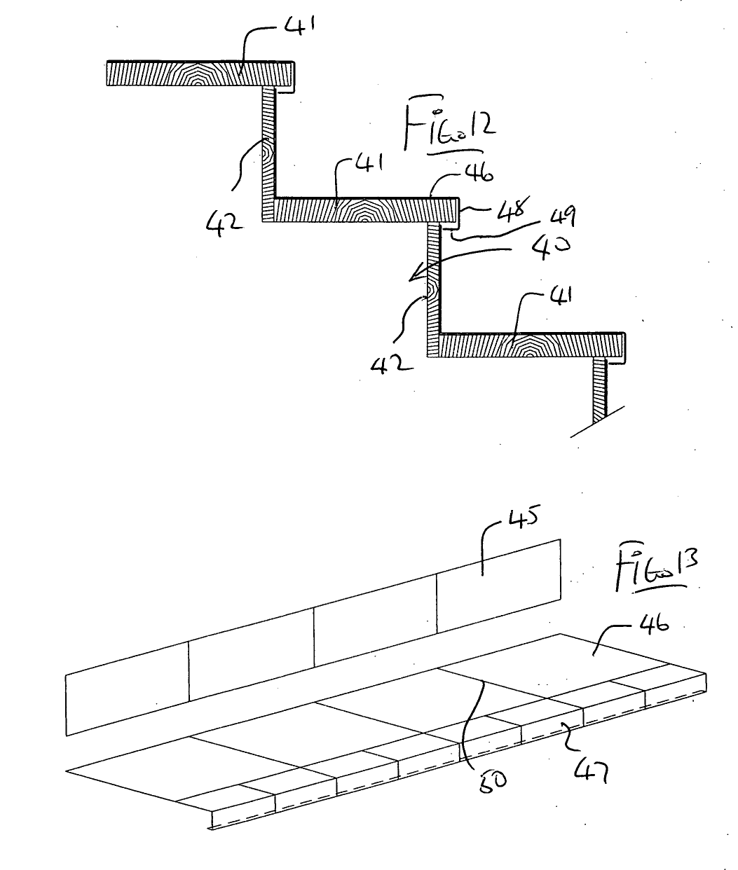

Turning now to FIGS. 12 and 13, there is shown a further embodiment for use with a stair generally indicated at 40 including a series of treads 41 and a series of kick-plates 42. In this embodiment the flooring structure described above is formed into a kick-plate 45 and a tread-plate 46 which are shaped and arranged to match the width of the stair and the depth of the tread and the kick-plate. Thus the kick-plate 45 is applied by adhesive over the kick-plate 42 of the stair. Thus the tread-plate 46 includes a flat panel portion overlying the upper surface of the tread together with a nose portion 47 which includes a down-turned element 48 and an underside return portion 49. Thus these portions are arranged so that the portion 48 is at right angles to the flat portion 46 to extend downwardly over the nose of the tread and the portion 49 is again turned backwardly or rearwardly to lie underneath the tread. The panels are of course formed in the manner previously described to include the substrate sheet of metal together with the overlying layer of the polymer concrete which is machined to form the grout lines indicated at 50. In this case there is no interconnection between one panel and the next since the panels are cut and formed to shape and size to match the size of the treads of the stair. The system can provide panels which match the shape of an existing stair with the slip over cover stair kick and tread and or end caps.

Since various modifications can be made in my invention as herein above described, and many apparently widely different embodiments of same made within the spirit and scope of the claims without department from such spirit and scope, it is intended that all matter contained in the accompanying specification shall be interpreted as illustrative only and not in a limiting sense.

1. A floor or wall covering comprising:
a plurality of flooring panels;
each panel including a flat sheet formed from sheet metal;
the sheet being shaped in plan such that the panels can be arranged in an array to cover a floor or wall;
each sheet being covered by a set layer of a material designed to simulate tile;
the layer of each panel having grooves formed therein to simulate grout lines;
the grooves being filled by a grout material;
the layer being colored by a coloring material;
the layer being covered by a clear coat.

2. The covering according to claim 1 wherein each panel has along the side edges thereof recesses and projections thereon for connecting to corresponding projections and recesses on the side edge of a next adjacent panel allowing the panels to interconnect to cover a floor area and wherein the panels are formed into an interconnected array by each panel being laid next to and interlocked with the adjacent panel to form one entire connected surface which essentially floats over the existing floor to form a resilient floor that will flex.

3. The covering according to claim 1 wherein the panels are applied onto an existing flooring by a layer of a urethane foam.

4. The covering according to claim 1 wherein the sheets are stamped from sheet metal.

5. The covering according to claim 1 wherein the panels are square.

6. The covering according to claim 2 wherein the projections and recesses form a castellated shape along the edge.

7. The covering according to claim 6 wherein the projections have side edges which are all the same size inclined outwardly to increase in width away from the side edge and the recesses are shaped to match to form an interlocking reversing notched edge.

8. The floor covering according to claim 1 wherein material designed to simulate tile is a cross linking polymer cement containing an aggregate.

9. The floor covering according to claim 8 wherein the aggregate is a crushed powdered stone.

10. The floor covering according to claim 1 wherein layer is applied at a manufacturing plant as a slurry which is applied over the surface of the sheet metal in a thin layer and allowed to harden.

11. The floor covering according to claim 1 wherein the grout lines on the interior of the sheet are grouted with a latex grout.

12. The floor covering according to claim 1 wherein the sheet is a flexible 14 to 16 gauge sheet.

13. The floor covering according to claim 3 wherein the polyurethane foam is dispensed from a gun applicator in spaced rows so that the flooring is resilient.

14. The floor covering according to claim 2 wherein each panel is locked into the next tile by tapping the projections and recesses forming opposing angled mortise shapes together.

15. The floor covering according to claim 2 wherein the panels form an entirely joined floor in all directions which allows the floor covering to float over any stable substrate.

16. The floor covering according to claim 2 wherein the locked joints between panels are sealed with a liquid sealer which prevents water penetration.

17. The floor covering according to claim 2 wherein the locked joints between panels are connected together with liquid glue.

18. The floor covering according to claim 1 wherein there is provided a sheet of a high density foam underneath the panel and on top of a sub floor.

19. The floor covering according to claim 18 wherein the sheet of foam provides a support for heating coils.

20. The floor covering according to claim 1 wherein each panel is shaped to fit on a single stair tread.

21. The floor covering according to claim 20 wherein each stair panel includes a front nose portion bent at right angles to extend downwardly and bent back to extend rearwardly to cover a tread nose of the stair tread.

22. The floor covering according to claim 20 wherein there is provided a second tread portion to form a kick plate for the stair tread.
